(19) United States
(12) Patent Application Publication
(10) Pub. No.: US 2015/0237470 A1
(43) Pub. Date: Aug. 20, 2015

(54) Personal Geofence

(71) Applicant: Apple Inc., Cupertino, CA (US)

(72) Inventors: Robert Mayor, Half Moon Bay, CA (US); Lukas M. Marti, Santa Clara, CA (US); Shannon M. Ma, San Francisco, CA (US)

(73) Assignee: Apple Inc., Cupertino, CA (US)

(21) Appl. No.: 14/180,731

(22) Filed: Feb. 14, 2014

(51) Int. Cl. H04W 4/02

(52) U.S. Cl. CPC H04W 4/021

(57) ABSTRACT

Systems, methods and computer program products for providing location-based services triggered by a personal geofence are disclosed. A mobile device can determine that a venue located at a geographic location and frequently visited by the mobile device in the past is associated with a particular item, service, or activity. Upon receiving a query about the item, service, or activity, the mobile device can create a temporary geofence around the venue. Using past behavior patterns and a current location, the mobile device can determine a condition to trigger execution of an application program or display of certain content. The condition can be personalized to match a life style of a user of the mobile device. Accordingly, trigging the execution of the application program or the display of the content may be based on factors other than a distance between the mobile device and a point location.

### TECHNICAL FIELD

This disclosure is related generally to location-based services.

### BACKGROUND

Some mobile devices have features for providing location-based services. For example, a mobile device can execute a pre-specified application program or present certain content when the mobile device enters or exits a geofence. The geofence can be defined by a point location and a radius. The point location can have a longitude coordinate and a latitude coordinate. The mobile device can determine that the mobile device has entered the geofence or exited the geofence by determining an estimated location of the mobile device and calculating a distance between the estimated location and the point location. Based on whether the calculated distance exceeds the radius of the geofence, the mobile device can determine whether the mobile device entered or exited the geofence. The mobile device can determine the estimated location, which also includes a longitude coordinate and a latitude coordinate, using a global satellite system (e.g., GPS) or cellular triangulation.

### SUMMARY

Systems, methods and computer program products for providing location-based services triggered by a personal geofence are disclosed. A mobile device can determine that a venue located at a geographic location and frequently visited by the mobile device in the past is associated with a particular item, service, or activity. Upon receiving a query about the item, service, or activity, the mobile device can create a temporary geofence around the venue. Using past behavior patterns and a current location, the mobile device can determine a condition to trigger execution of an application program or display of certain content. The condition can be personalized to match a life style of a user of the mobile device. Accordingly, trigging the execution of the application program or the display of the content may be based on factors other than a distance between the mobile device and a point location.

The features described in this specification can be implemented to achieve one or more advantages. Compared to conventional geofence technologies, the techniques described in this specification can provide services that are more personal and more tailored to a user's particular life style. For example, a mobile device implementing the described techniques can provide a reminder to a user moving towards a destination location before reaching that destination location. The mobile device can provide the reminder many miles away, or when a user of the mobile device “drives by” the destination location, rather than providing the reminder when the user is already at the destination location.

The mobile device can trigger launching an application program based on various sensors of the mobile device to adjust to a user's movement. For example, the mobile device can be programmed to display a reminder to buy an item at a store. A mobile device may estimate that the user is travelling on a highway towards the store. In response, the mobile device can trigger the reminder before the mobile device reaches a highway exit that leads to the store. Whereas, when the mobile device estimates that the user is walking toward the store, the mobile device can trigger the reminder when the mobile device is or one or two street blocks from the store.

In addition, a mobile device implementing the described techniques can balance conservation of power and accuracy of location better than a conventional mobile device. The mobile device can switch on power-hungry functions, e.g., location determination using global positioning system (GPS) signals, more frequently upon determining that a probability that the mobile device is heading to a destination is high. The more frequent usage of GPS location determination can reduce the chances that the mobile device passes by and misses a destination. The more frequent usage of GPS location determination does not waste power because the more frequent usage is based upon a condition that the mobile device already determined that the probability of the mobile device moving to the destination is high

The details of the disclosed implementations are set forth in the accompanying drawings and the description below. Other features, objects, and advantages will be apparent from the description and drawings, and from the claims.

### DESCRIPTION OF DRAWINGS

FIG. 1 is a diagram illustrating an exemplary use case of a personal geofence.

FIG. 2 is a diagram of interaction between a user and an exemplary mobile device providing services based on a personal geofence.

FIGS. 3A and 3B illustrate exemplary location determination techniques of a mobile device.

FIG. 4 is a block diagram of components of an exemplary mobile device implementing personal geofence.

FIG. 5 is a flowchart of an exemplary personal geofence process.

FIG. 6 is a block diagram illustrating an exemplary device architecture of a mobile device implementing the features and operations of FIGS. 1-5.

FIG. 7 is a block diagram of an exemplary network operating environment for the mobile devices implementing the features and operations of FIGS. 1-5.

FIG. 8 is a block diagram of exemplary architecture 800 for a server implementing the features and operations described in reference to FIGS. 1-5.

The same reference symbol used in various drawings indicates like elements.

### DETAILED DESCRIPTION

### Exemplary Personal geofence

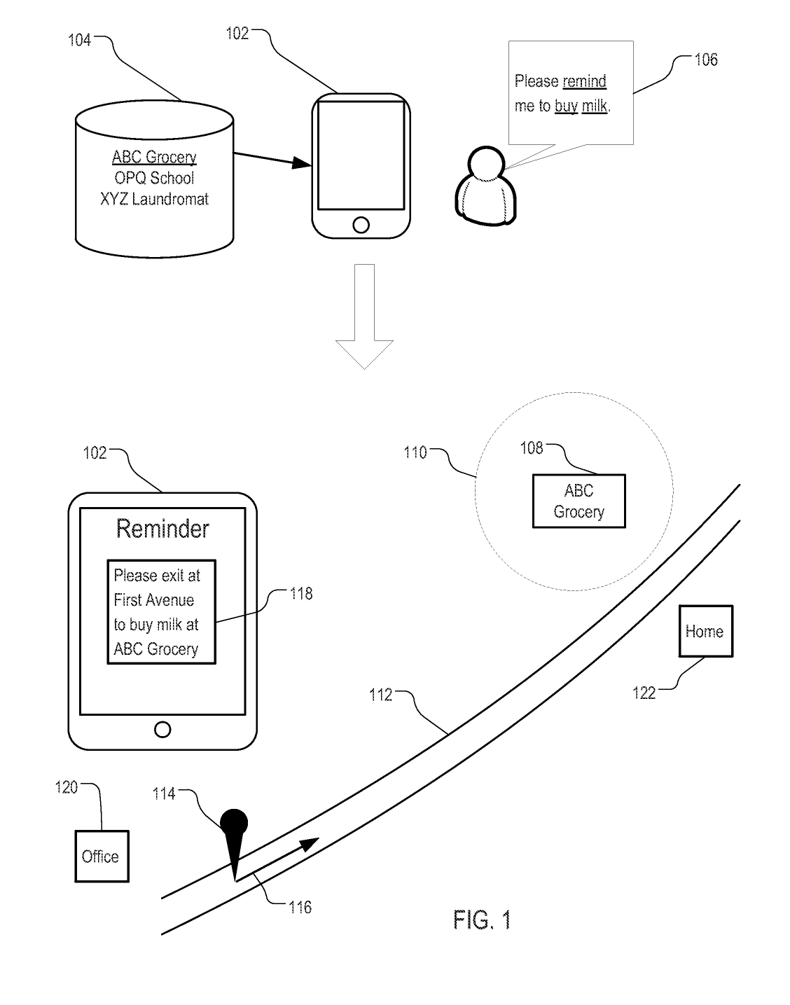

FIG. 1 is a diagram illustrating an exemplary use case of personal geofence. Mobile device 102 is an exemplary device implementing personal geofence technologies. Mobile device 102 can include, or be coupled to, significant location database 104. Significant location database 104 can store representations of one or more significant locations, e.g., “ABC Grocery,” “OPQ School,” or “XYZ Laundromat.” Each significant location can be a location that has some significance in the life of a user of mobile device 102. For example, a significant location can be a location at which the user stayed for more than a threshold amount of time, a location that the user visited for more than a threshold number of times, or a location that the user entered as a travel destination in an address database and subsequently visited.

Mobile device 102 can create a personal geofence around one or more of the significant locations. A personal geofence can be a geofence that is defined using information that is additional to, or alternative to, geographic coordinates and a radius. A conventional geofence may trigger launching of an application or displaying location specific content when a mobile device enters, or exits, a circle defined the geographic coordinates and a radius. By comparison, mobile device 102 can trigger launching of an application or displaying location specific content upon determining that a likelihood that mobile device 102 heads toward a general direction of a location exceeds a threshold value. In addition, the personal geofence is associated with a particular activity specified by the user.

In the example shown, mobile device 102 receives input 106. Input 106 can be voice input, a typed input, or a written input. In the example shown, input 106 includes a message, “Please remind me to buy milk.” Mobile device 102 can parse input 106 using a service local to mobile device 102 or a service provided by a remote server. As result of the parsing, mobile device 102 can identify keywords “remind,” “buy,” and “milk.” Mobile device 102 can determine that the keyword “remind” is a functional word trigging creation of a personal geofence for a reminder function or application of mobile device 102. In addition, mobile device 102 can determine that “buy milk” is a particular activity associated with the personal geofence.

Using the local or remote service, mobile device 102 can determine one or more significant locations in significant location database 104 are related to the particular activity. For example, mobile device 102 can determine that a significant location “ABC Grocery” is a business classified as a grocery store where a user can “buy” an item. In addition, mobile device 102 can determine that the keyword “milk” is a grocery item. As a result, mobile device 102 can determine that the keyword “buy” and the keyword “milk” links input 106 to the significant location “ABC Grocery.” In response, mobile device 102 can create a personal geofence around the store “ABC Grocery” and associate the personal geofence with the reminder, even though the input 106 makes no mention of “ABC Grocery.”

The personal geofence need not coincide with a conventional geofence of “ABC Grocery.” For example, “ABC Grocery” may be located at location 108. Geofence 110 can be a conventional geofence for “ABC Grocery.” Implementing the personal geofence, mobile device 102 may provide the reminder to buy milk even when mobile device 102 is located outside of conventional geofence 110.

In the example shown, mobile device 102 determines that a user carrying mobile device 102 moves towards “ABC Grocery.” Mobile device 102 can determine that mobile device 102 is traveling on highway 112. In addition, mobile device 102 can determine that mobile device 102 is located at a current location 114, and has a heading 116. Mobile device 102 can determine, based on a current velocity of mobile device 102 and the current location 114, mobile device may reach “ABC Grocery” in X minutes, where X is a pre-specified threshold time. In response, mobile device 102 can provide user interface 118 to the user. User interface 118 can be a visual or audio reminder for buying milk at “ABC Grocery.”

Determining that mobile device 102 is located at location 114 and has heading 116 can involve operations that are power hungry. For example, the operations can include turning on a GPS receiver and determining location 114 and heading 116 using an application processor. Mobile device 102 can conserve battery power by triggering these operations only when mobile device 102 is reasonably certain that performing these operations will likely result in a positive identification that mobile device 102 will enter the personal geofence. Mobile device 102 can be “reasonably certain” upon determining that, due to past activities, mobile device 102 is likely to be approaching location 108 of “ABC Grocery.”

For example, mobile device 102 can determine, based on past usage patterns, that a user of the mobile device 102 usually leaves office 120 at 6:00 pm during week days, and reaches home 122 at 7:00 pm, following highway 112 or some other route. Accordingly, mobile device 102 can determine that a likelihood that mobile device 102 will be traveling on highway 112 during the time between 6:00 pm and 7:00 pm on a week day exceeds a threshold value. In response, mobile device 102 can automatically turn on location monitoring shortly after 6:00 pm on a weekday.

As FIG. 1 and corresponding descriptions have shown, providing user interface 118 is a result of inputs including pre-determined significant locations of mobile device 102 (e.g., “ABC Grocery”), meaning of the significant locations to the user (e.g., “ABC Grocery” is a grocery store), input 106 (e.g., “remind me to buy milk”), backend analysis linking the meaning to the input (e.g., a grocery store sells milk), and a pre-determined pattern of the user (e.g., leaving office for home at 6:00 pm). Accordingly, the geofence created by mobile device 102 is personal, tailored particular to the user, and specific, e.g., for a reminder of buying milk. Mobile device 102 can trigger the reminder when mobile device 102 is on the road, e.g., driving by.

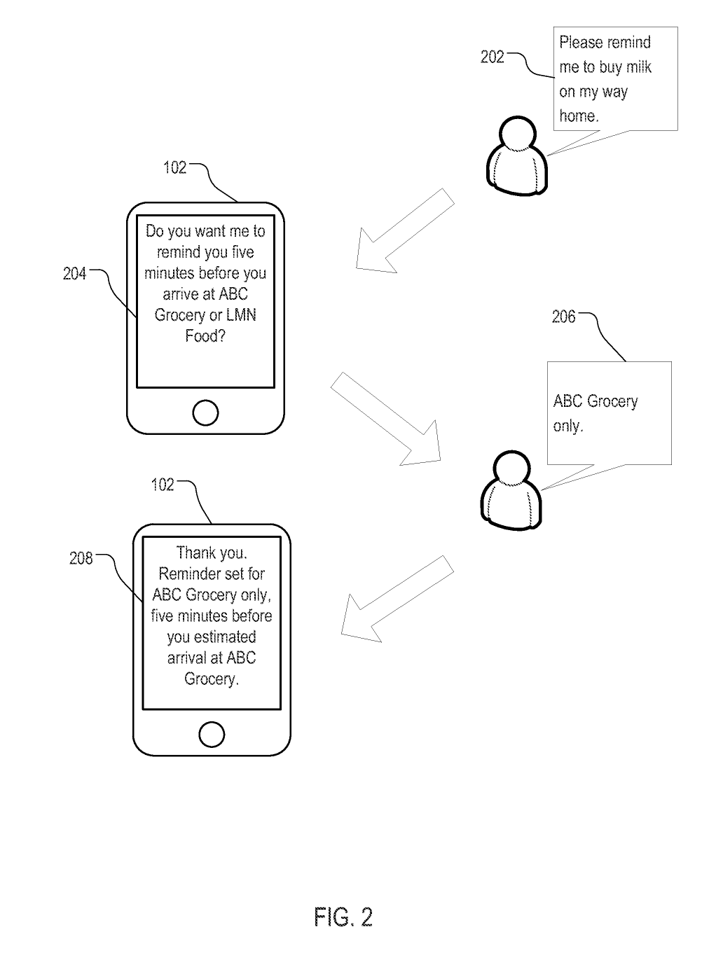

FIG. 2 is a diagram of interaction between a user and exemplary mobile device 102 providing services based on a personal geofence. Mobile device 102 can receive voice or text input 202, “Please remind me to buy milk on my way home.” Mobile device 102, using a service local to mobile device 102 or remotely provide by a server connected to mobile device 102 through a communication network, recognizes terms “remind,” “buy,” “milk,” and “way home.” Mobile device 102 then makes a “best guess” on how to set up a personal geofence to respond to the input.

In making the best guess, mobile device 102 can identify, from significant locations determined in the past, those significant locations that relate to an activity “buy” from input 202. To identify the related significant locations, mobile device can use a local or remote dictionary that maps a business type of each significant location to the activity. For example, a grocery store, restaurant, gas station may be mapped to activities of “buy” or “purchase.” Mobile device 102 can filter the business type with additional mappings. For example, mobile device 102 can select grocery stores from the matching businesses based on “milk” according to a categorization of the term “milk” and filter out gas stations and restaurants. Mobile device 102 can further filter the grocery stores using the term “way home” by selecting “ABC Grocery” and “LMN Food,” two grocery stores that are on a route between the user's office and home.

Mobile device 102 can provide user interface item 204 to confirm if the best guess is acceptable to the user. User interface item 204 can include a visual display or speech output presenting the best guess. In addition, user interface item 204 can include a suggestion on how much lead time for providing the suggestions. For example, mobile device 102 can have a default setting that a reminder is provided X minutes before mobile device 102 is projected to arrive at any one of a location of “ABC Grocery” or a location of “LMN Food.”

Mobile device 102 can receive user input 206. User input 206 may confirm the suggested best guess, reject the suggested best guess, or modify the suggested best guess. For example, user input 206 may include a voice input stating “ABC Grocery only.” In response, mobile device 102 can modify the suggestion by removing “LMN Food” from the list of locations. Mobile device 102 can then provide user interface 208 confirming that a personal geofence is set for “ABC Grocery” and the reminder is set to go off X minutes before an estimated arrival at “ABC Grocery.”

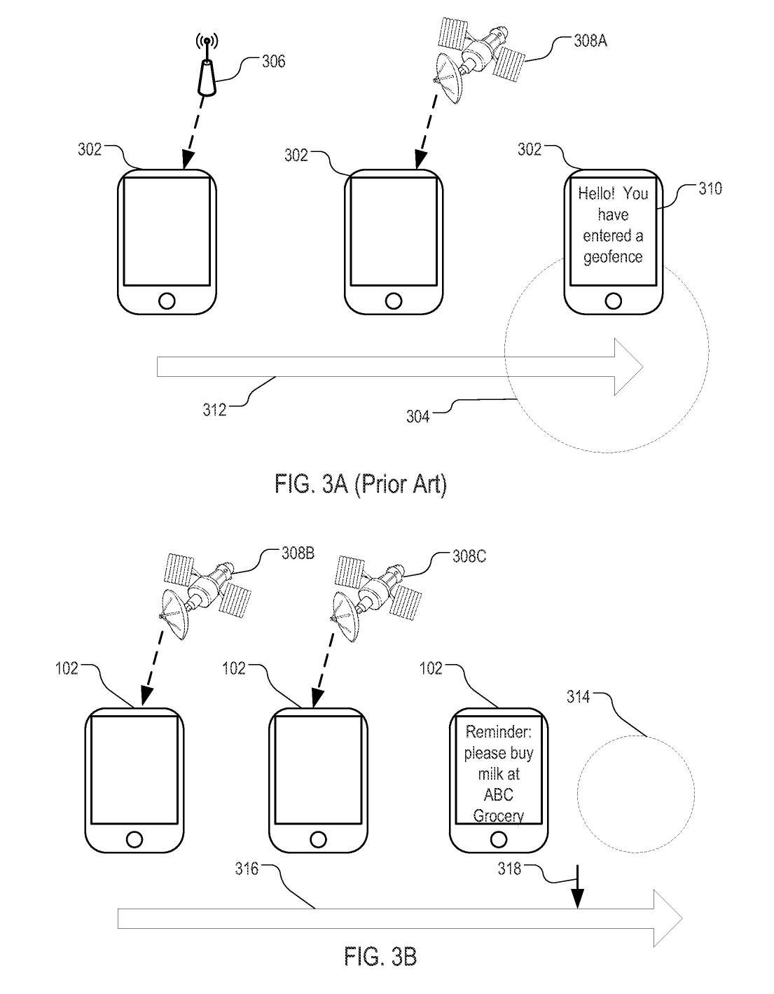

FIGS. 3A and 3B illustrate exemplary location determination techniques of a mobile device. FIG. 3A illustrates a conventional location determination techniques for conserving power. Mobile device 302 is programmed to trigger launching of an application upon entering geofence 304. Mobile device 302 can register one or more signal sources 306, e.g., cell towers or wireless access points, at a low-powered processor, e.g., a baseband processor, of mobile device 302. The wireless gateways can be located sufficiently close to geofence 304 such that mobile device 302, if located in geofence 304, can detect signals from the signal sources 306. During the time mobile device 302 is turned off, the low-power processor of mobile device 302 can periodically monitor airwave to determine whether mobile device 302 receives signals from the signal sources 306. Upon detecting such a signal, the low-power processor can notify an application processor. The application processor can determine a location of the mobile device 302 using another method, e.g., by using GPS signals from satellite 308A. Upon detecting that mobile device 302 crossed geofence 304, mobile device 302 can trigger the application and displays a message 310. Thus, when mobile device 302 moves along path 312, mobile device 302 can monitor location using different technology to save power when possible.

FIG. 3B illustrates location determination techniques for conserving power for a personal geofence. Mobile device 102 is programmed to perform a task related to location 314. Mobile device 102 can determine, based on various factors, that mobile device 102 may be moving to location 314. The factors can include time factors and location factors. Both the time factors and the location factors can be based on past behavior of a user of mobile device 102.

For example, mobile device 102 can determine that (1), location 314 is near a path between two significant locations, an office and a home, of the user. Mobile device 102 can determine that, (2), in the past, mobile device 102 took detours to travel to location 314 after leaving office and before reaching home. Mobile device 102 can determine that, (3), in the past, mobile device 102 usually leaves office at 6:00 pm and reaches home at 7:00 pm. Mobile device 102 can determine, using context information (1), (2), and (3) above, that turning on location monitoring may be worthwhile when balancing potential improvement on user experience against cost in battery power. Accordingly, mobile device 102 can determine to turn on low-power monitoring or to turn on the application processor to check a current location using signals from satellite 308B at a time that is proximate and subsequent to the time that mobile device 102 usually leaves office, e.g., at 6:05 pm.

For example, using the context information, mobile device 102 may determine that mobile device 102 is in a driving state. Mobile device 102 can then monitor a state of mobile device 102, including determining additional context information, using a low-power processor. Mobile device 102 can determine a coarse location of mobile device 102 or a heading of mobile device 102. If the heading is in the direction of location 314, mobile device 102 can turn on the application processor.

In some implementations, mobile device 102 can create a geofence at a current location of mobile device 102, e.g., the office. Mobile device 102 can use a geofencing feature of mobile device 102 to determine if mobile device 102 has exited the geofence, e.g., by leaving office. Upon determining that mobile device 102 exited the office, mobile device 102 can use the low-power processor or application processor to determine whether mobile device 102 is heading to location 314.

Upon determining that mobile device 102 is still in the office, or upon determining that a location of mobile device 102 cannot be fixed, mobile device 102 can turn off the application processor and set the application processor to turn on automatically after a pre-determined interval, e.g., five minutes.

Upon determining that mobile device 102 has left the office, mobile device 102 can determine a frequency of monitoring a location using satellite 308C. Mobile device 102 can determine the frequency based on whether mobile device is on path 316, which is usually taken by mobile device 102 from office to home. If mobile device 102 is located on path 316, the frequency can be higher. Additionally or alternatively, mobile device 102 can determine the frequency based on a velocity of mobile device 102. A higher velocity can correspond to a higher frequency. Additionally or alternatively, mobile device 102 can determine the frequency based on a distance between mobile device 102 and a road turn, e.g., a highway exit, that is on path to location 314. A shorter distance can correspond to a higher frequency.

Mobile device 102 can launch an application or display certain content before a pre-specified time for reaching location 314 or reaching a critical point 318. Critical point 318 can be a last opportunity to change a current heading for home to a heading to location 314 without significant detour. For example, mobile device 102 can determine that critical point 318 is a last highway exit for reaching location 314.

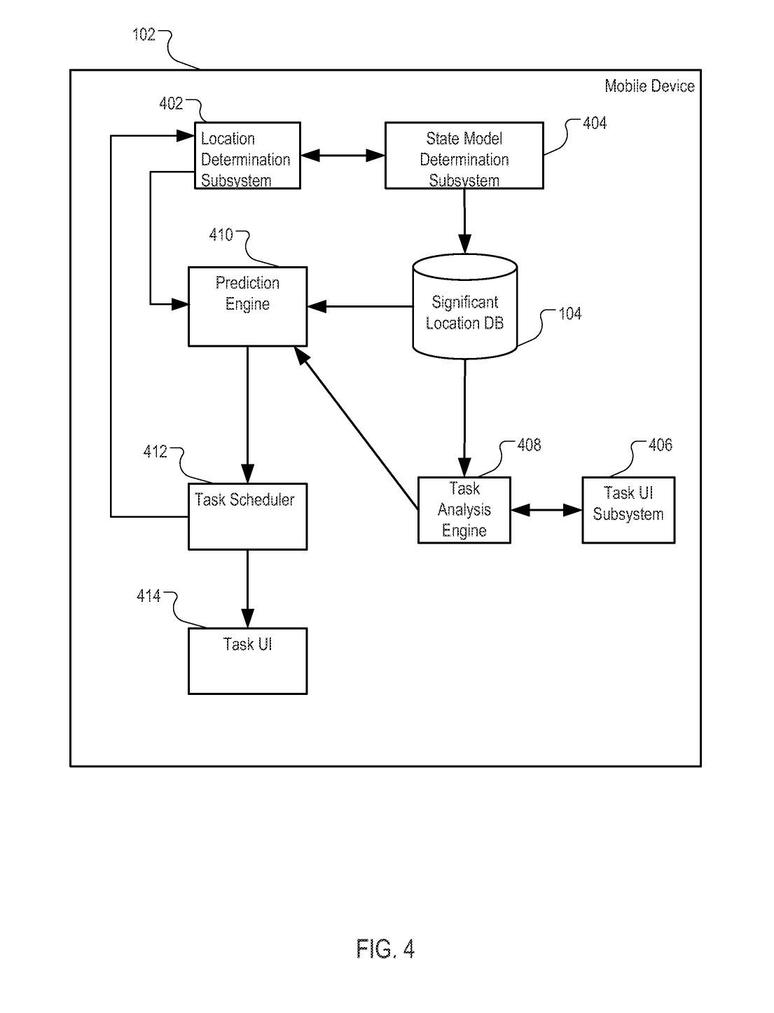

FIG. 4 is a block diagram of components of exemplary mobile device 102 implementing personal geofence. Mobile device 102 can include location determination subsystem 402. Location determination subsystem 402 is a component of mobile device 102 configured to determine a location of mobile device 102 using cell signal triangulation, known locations of wireless access points, GPS signals, or other techniques.

Mobile device 102 can include state model determination subsystem 404. State model determination subsystem 404 is a component of mobile device 102 configured to determine significant locations and time-based probability of transitions from one significant location to another significant location, e.g., from office to home, or from out-of-state locations to each significant location. An out-of-state location is a location not visited by mobile device 102 before or not registered as a significant location.

Mobile device 102 can include significant location database 104. Significant location database 104 is a component of mobile device 102 configured to store the significant locations determined by state model determination subsystem 404.

Mobile device 102 can include task user interface subsystem 406. Task user interface subsystem 406 is a component of mobile device 102 configured to receive a user input for creating a personal fence based task, and to provide best guesses for creating the task to the user. Task user interface subsystem 406 can include speech recognition and speech synthesization hardware and software or firmware.

Mobile device 102 can include task analysis engine 408. Task analysis engine 408 is a component of mobile device 102 that parses the user input received from task user interface subsystem 406 for keywords, to determine one or more significant locations that are related to the keywords, and to filter the one or more significant locations based on additional input from task user interface subsystem 406. Some or all functions of task analysis engine 408 can be performed using services located remotely from mobile device 102. Output of the task analysis engine 408 can include selected significant locations associated with the task specified in the user input.

Mobile device 102 can include prediction engine 410. Prediction engine 410 is a component of mobile device 102 configured to predict a time that mobile device will visit a significant location selected by task analysis engine 408, or reach a decision location, e.g., a highway exit, that is on a route leading to the significant location. Prediction engine 410 can make the prediction based on a current location as determined by location determination subsystem 402, a current time, and significant locations and transit probabilities stored in the significant location database 104. Prediction engine 410 can then provide the time to task scheduler 412.

Task scheduler 412 is a component of mobile device 102 configured to determine a plan for monitoring a current location and to control location determination subsystem 402 according to the plan. For example, task scheduler 412 can increase a location monitor frequency upon determining that mobile device 102 is located close to a highway exit that is on a route leading to the significant location. In addition, task scheduler 412 can specify a condition that, when satisfied, triggers launching of the task. For example, task scheduler 412 can specify that a reminder to buy an item at a store be launched X minutes before mobile device 102 reaches a highway exit that leads to the store. Task scheduler 412 can then launch the task when a distance between a location of mobile device 102 and the highway exit, divided by a velocity of the mobile device 102, satisfies the X minutes. Upon launching the task, mobile device 102 can present a message through task user interface 414. Task user interface 414 can include a speech, visual, or vibration output.

### Exemplary Process

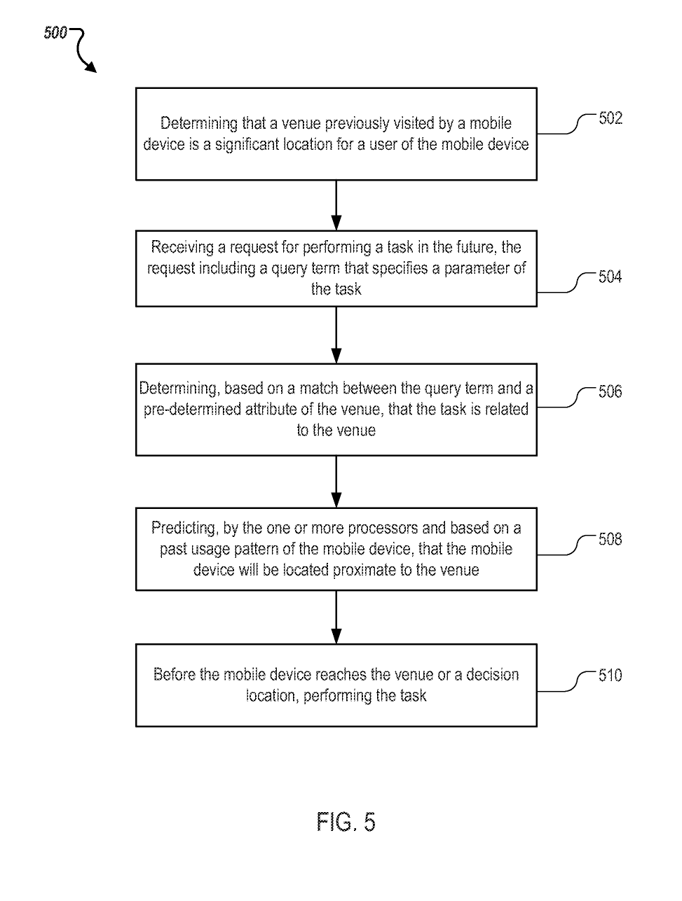

FIG. 5 is a flowchart of an exemplary personal geofence process 500. Process 500 may be performed by a system, e.g., mobile device 102 of FIGS. 1-4, or one or more server computers remotely connected to mobile device 102. The system can include one or more processors.

The system can determine (502), using state model determination subsystem 404 of FIG. 4, that a venue previously visited by a mobile device is a significant location for a user of the mobile device. Determining that the venue is a significant location can include determining that the user previously visited the venue at a frequency that is higher than a threshold frequency. Determining that the venue is a significant location can include determining that the user previously stayed at the venue for more than a threshold amount of time. Determining that the venue is a significant location can include determining that the user previously purchased an item or a service at the venue, or any combination of the above.

The system can receive (504), using task user interface subsystem 406 of FIG. 4, a request for performing a task in the future. The request can include a query term that specifies a parameter of the task. The request can be a natural language speech input. The task can include providing a reminder for performing an activity related to the query term.

The system can determine (506), using task analysis engine 408 and based on a match between the query term and a pre-determined attribute of the venue, that the task is related to the venue. The system can determine that the task is related to the venue upon determining that a merchandise item or a service identified by the query term is sold at the venue, or an activity identified by the query term is performed at the venue. For example, the system can determine that a reminder for “picking up kids” as specified in query term is related to a venue “OPQ School” and that a reminder for “dry cleaning” as specified in query term is related to a venue “XYZ Laundromat.”

The system can predict (508), using prediction engine 410 of FIG. 4 and based on a past usage pattern of the mobile device, that the mobile device will be located proximate to the venue. Predicting that the mobile device will be located proximate to the venue can include monitoring a geographic or temporal distance between the mobile device and the venue according to a location sampling plan, the location sampling plan being determined based on a current location of the mobile device, a current motion reading of the mobile device, and the past usage pattern. The system can then determine that the mobile device will be located at the venue after a pre-specified lead time.

Predicting that the mobile device will be located proximate to the venue can include performing the following operations. The system can determine, based on the transit information and a current location of the mobile device, that a probability that the mobile device is transiting from the first significant location to the second significant location exceeds a threshold value. The system can determine that, in the past, the mobile device visited the venue during a transit from the first geographic location to the second geographic location, e.g., by taking a detour. The system can then predicting that the mobile device will be located proximate to the venue based on the current location and a heading of the mobile device. Predicting that the mobile device will be located proximate to the venue can occur before the mobile device enters a stationary geofence of the venue.

The past usage pattern can include location information and transit information. The location information including a geographic coordinates of a significant location, and in some implementations, a probability that the mobile device is located at the geographic location at a given time. The transit information can include a probability that the mobile device transits from a first significant location to a second significant location at given time.

The system can determine the location sampling plan using operations as follows. The system can determine determining, based on a travel velocity of the mobile device and the geographic distance between the mobile device and the venue, that a first location determination mechanism of the mobile device may have insufficient time to trigger performance of the task. In response, the system can monitor the geographic distance or temporal distance using a second location determination mechanism. In some implementations, the first location determination mechanism determines the current location of the mobile device using signals from one or more wireless local area network (WLAN), and the second location determination mechanism determines the current location of the mobile device using signals from a satellite positioning system.

Before the mobile device reaches the venue or a decision location, the system can perform (510) the task. The decision location is a location for the user to make a choice between continuing on a current travel path or making a detour for visiting the venue.

### Exemplary Mobile Device Architecture

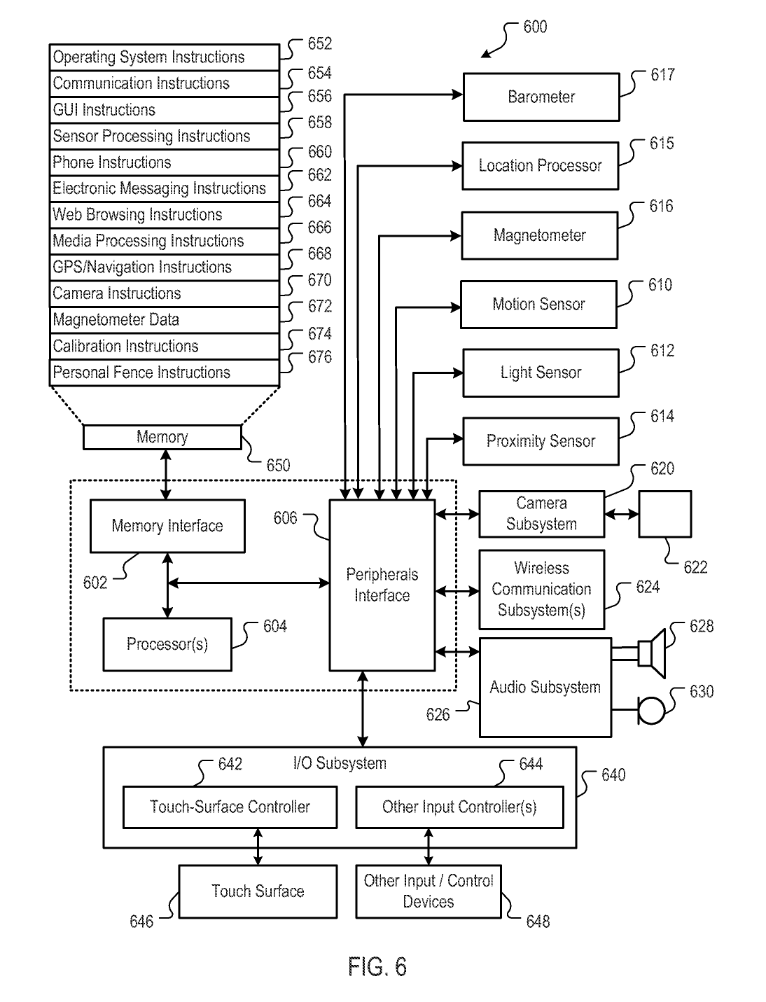

FIG. 6 is a block diagram illustrating exemplary device architecture 600 of a mobile device implementing the features and operations of personal geofence. A mobile device (e.g., mobile device 102) can include memory interface 602, one or more data processors, image processors and/or processors 604, and peripherals interface 606. Memory interface 602, one or more processors 604 and/or peripherals interface 606 can be separate components or can be integrated in one or more integrated circuits. Processors 604 can include application processors, baseband processors, and wireless processors. The various components in mobile device 102, for example, can be coupled by one or more communication buses or signal lines.

Sensors, devices, and subsystems can be coupled to peripherals interface 606 to facilitate multiple functionalities. For example, motion sensor 610, light sensor 612, and proximity sensor 614 can be coupled to peripherals interface 606 to facilitate orientation, lighting, and proximity functions of the mobile device. Location processor 615 (e.g., GPS receiver) can be connected to peripherals interface 606 to provide geopositioning. Electronic magnetometer 616 (e.g., an integrated circuit chip) can also be connected to peripherals interface 606 to provide data that can be used to determine the direction of magnetic North. Thus, electronic magnetometer 616 can be used as an electronic compass. Motion sensor 610 can include one or more accelerometers configured to determine change of speed and direction of movement of the mobile device. Barometer 617 can include one or more devices connected to peripherals interface 606 and configured to measure pressure of atmosphere around the mobile device.

Camera subsystem 620 and an optical sensor 622, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 624, which can include radio frequency receivers and transmitters and/or optical (e.g., infrared) receivers and transmitters. The specific design and implementation of the communication subsystem 624 can depend on the communication network(s) over which a mobile device is intended to operate. For example, a mobile device can include communication subsystems 624 designed to operate over a GSM network, a GPRS network, an EDGE network, a Wi-Fi™ or WiMAX™ network, and a Bluetooth™ network. In particular, the wireless communication subsystems 624 can include hosting protocols such that the mobile device can be configured as a base station for other wireless devices.

Audio subsystem 626 can be coupled to a speaker 628 and a microphone 630 to facilitate voice-enabled functions, such as voice recognition, voice replication, digital recording, and telephony functions. Audio subsystem 626 can be configured to receive voice commands from the user.

I/O subsystem 640 can include touch surface controller 642 and/or other input controller(s) 644. Touch surface controller 642 can be coupled to a touch surface 646 or pad. Touch surface 646 and touch surface controller 642 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch surface 646. Touch surface 646 can include, for example, a touch screen.

Other input controller(s) 644 can be coupled to other input/control devices 648, such as one or more buttons, rocker switches, thumb-wheel, infrared port, USB port, and/or a pointer device such as a stylus. The one or more buttons (not shown) can include an up/down button for volume control of speaker 628 and/or microphone 630.

In one implementation, a pressing of the button for a first duration may disengage a lock of the touch surface 646; and a pressing of the button for a second duration that is longer than the first duration may turn power to mobile device 102 on or off. The user may be able to customize a functionality of one or more of the buttons. The touch surface 646 can, for example, also be used to implement virtual or soft buttons and/or a keyboard.

In some implementations, mobile device 102 can present recorded audio and/or video files, such as MP3, AAC, and MPEG files. In some implementations, mobile device 102 can include the functionality of an MP3 player. Mobile device 102 may, therefore, include a pin connector that is compatible with the iPod. Other input/output and control devices can also be used.

Memory interface 602 can be coupled to memory 650. Memory 650 can include high-speed random access memory and/or non-volatile memory, such as one or more magnetic disk storage devices, one or more optical storage devices, and/or flash memory (e.g., NAND, NOR). Memory 650 can store operating system 652, such as Darwin, RTXC, LINUX, UNIX, OS X, WINDOWS, iOS, or an embedded operating system such as VxWorks. Operating system 652 may include instructions for handling basic system services and for performing hardware dependent tasks. In some implementations, operating system 652 can include a kernel (e.g., UNIX kernel).

Memory 650 may also store communication instructions 654 to facilitate communicating with one or more additional devices, one or more computers and/or one or more servers. Memory 650 may include graphical user interface instructions 656 to facilitate graphic user interface processing; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions; media processing instructions 666 to facilitate media processing-related processes and functions; GPS/Navigation instructions 668 to facilitate GPS and navigation-related processes and instructions; camera instructions 670 to facilitate camera-related processes and functions; magnetometer data 672 and calibration instructions 674 to facilitate magnetometer calibration. The memory 650 may also store other software instructions (not shown), such as security instructions, web video instructions to facilitate web video-related processes and functions, and/or web shopping instructions to facilitate web shopping-related processes and functions. In some implementations, the media processing instructions 666 are divided into audio processing instructions and video processing instructions to facilitate audio processing-related processes and functions and video processing-related processes and functions, respectively. An activation record and International Mobile Equipment Identity (IMEI) or similar hardware identifier can also be stored in memory 650. Memory 650 can store personal fence instructions 676 that include computer instructions that, upon execution, can cause processor 604 to perform the operations of determining a personal geofence, including performing process 500.

Each of the above identified instructions and applications can correspond to a set of instructions for performing one or more functions described above. These instructions need not be implemented as separate software programs, procedures, or modules. Memory 650 can include additional instructions or fewer instructions. Furthermore, various functions of the mobile device may be implemented in hardware and/or in software, including in one or more signal processing and/or application specific integrated circuits.

### Exemplary Operating Environment

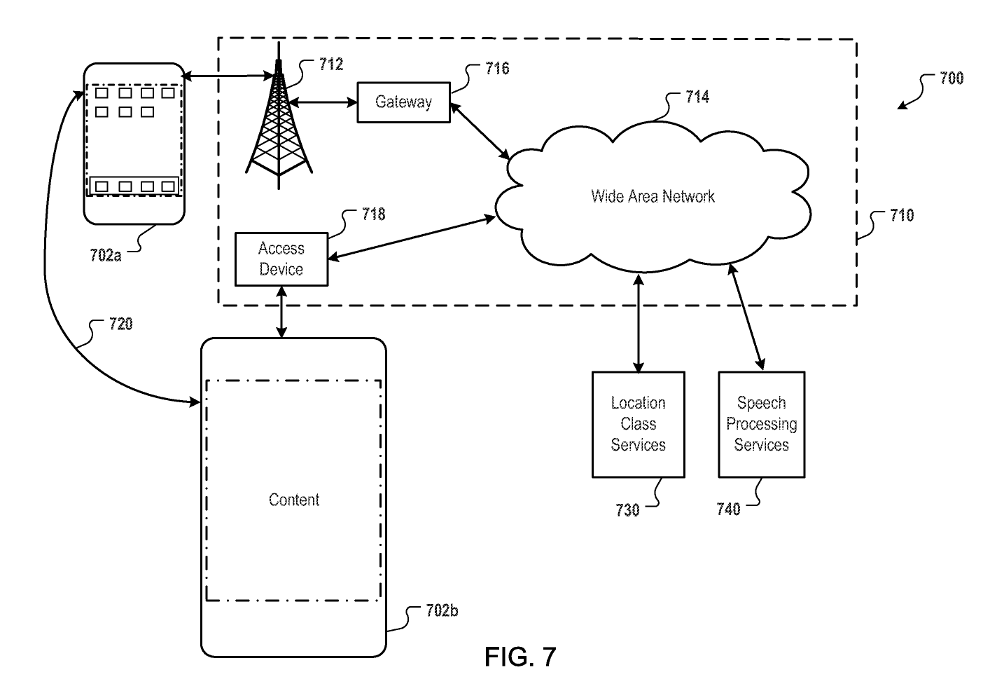

FIG. 7 is a block diagram of exemplary network operating environment 700 for the mobile devices implementing the features and operations of personal geofence. Mobile devices 702a and 702b can, for example, communicate over one or more wired and/or wireless networks 710 in data communication. For example, a wireless network 712, e.g., a cellular network, can communicate with a wide area network (WAN) 714, such as the Internet, by use of a gateway 716. Likewise, an access device 718, such as an 802.11g wireless access point, can provide communication access to the wide area network 714. Each of mobile devices 702a and 702b can be mobile device 102.

In some implementations, both voice and data communications can be established over wireless network 712 and the access device 718. For example, mobile device 702a can place and receive phone calls (e.g., using voice over Internet Protocol (VoIP) protocols), send and receive e-mail messages (e.g., using Post Office Protocol 3 (POP3)), and retrieve electronic documents and/or streams, such as web pages, photographs, and videos, over wireless network 712, gateway 716, and wide area network 714 (e.g., using Transmission Control Protocol/Internet Protocol (TCP/IP) or User Datagram Protocol (UDP)). Likewise, in some implementations, the mobile device 702b can place and receive phone calls, send and receive e-mail messages, and retrieve electronic documents over the access device 718 and the wide area network 714. In some implementations, mobile device 702a or 702b can be physically connected to the access device 718 using one or more cables and the access device 718 can be a personal computer. In this configuration, mobile device 702a or 702b can be referred to as a “tethered” device.

Mobile devices 702a and 702b can also establish communications by other means. For example, wireless device 702a can communicate with other wireless devices, e.g., other mobile devices, cell phones, etc., over the wireless network 712. Likewise, mobile devices 702a and 702b can establish peer-to-peer communications 720, e.g., a personal area network, by use of one or more communication subsystems, such as the Bluetooth™ communication devices. Other communication protocols and topologies can also be implemented.

Mobile device 702a or 702b can, for example, communicate with one or more services 730 and 740 over the one or more wired and/or wireless networks. For example, one or more location classification services 730 can identify and classify significations, including, for example, designating a significant location as “ABC Grocery” upon determining that geographic coordinates of the significant location match those of a “ABC Grocery” as stored in the system. In addition, location classification services 730 can determine that “ABC Grocery” is a grocery store, based on registration information provided by “ABC Grocery.” Speech processing services 740 can parse a voice input submitted by mobile device 702a or 702b, identify one or more keywords from the parsing, and provide the identified keywords to mobile device 702a or 702b.

Mobile device 702a or 702b can also access other data and content over the one or more wired and/or wireless networks. For example, content publishers, such as news sites, Really Simple Syndication (RSS) feeds, web sites, blogs, social networking sites, developer networks, etc., can be accessed by mobile device 702a or 702b. Such access can be provided by invocation of a web browsing function or application (e.g., a browser) in response to a user touching, for example, a Web object.

As described above, some aspects of the subject matter of this specification include gathering and use of data available from various sources to improve services a mobile device can provide to a user. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

### Exemplary Server Architecture

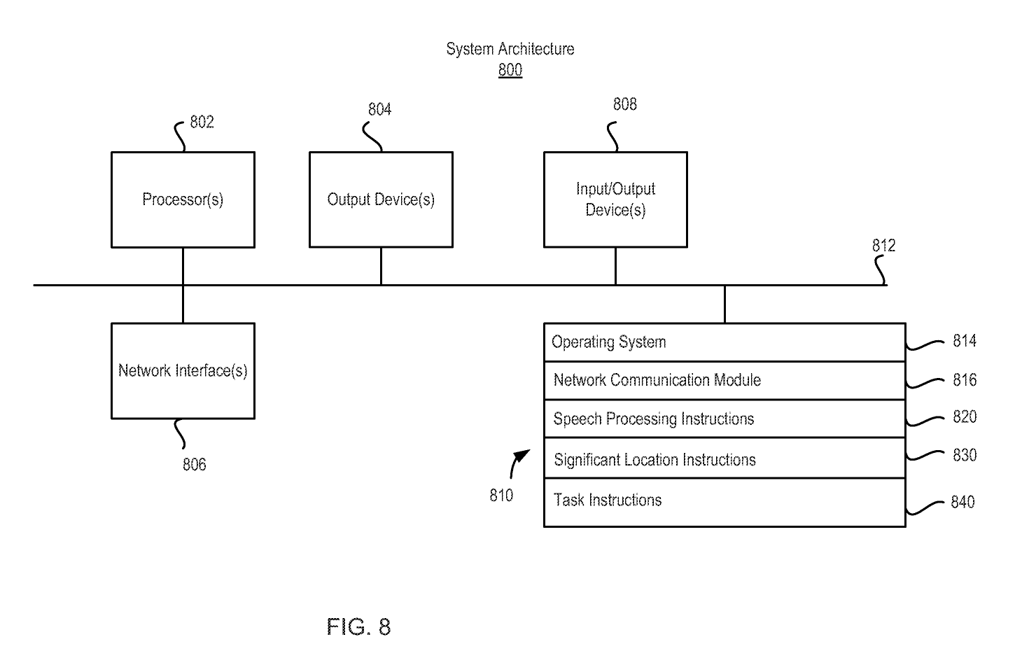

FIG. 8 is a block diagram of exemplary architecture 800 for a server implementing the features and operations described in reference to FIGS. 1-5. Architecture 800 may be implemented on any data processing apparatus that runs software applications derived from instructions, including without limitation personal computers, smart phones, electronic tablets, game consoles, servers or mainframe computers. In some implementations, the architecture 800 may include processor(s) 802, storage device(s) 804, network interfaces 806, Input/Output (I/O) devices 808 and computer-readable medium 810 (e.g., memory). Each of these components may be coupled by one or more communication channels 812.

Communication channels 812 may be any known internal or external bus technology, including but not limited to ISA, EISA, PCI, PCI Express, NuBus, USB, Serial ATA or FireWire.

Storage device(s) 804 may be any medium that participates in providing instructions to processor(s) 802 for execution, including without limitation, non-volatile storage media (e.g., optical disks, magnetic disks, flash drives, etc.) or volatile media (e.g., SDRAM, ROM, etc.).

I/O devices 808 may include displays (e.g., touch sensitive displays), keyboards, control devices (e.g., mouse, buttons, or scroll wheel), loud speakers, audio jack for headphones, microphones and another device that may be used to input or output information.

Computer-readable medium 810 may include various instructions 814 for implementing an operating system (e.g., Mac OS®, Windows®, Linux). The operating system may be multi-user, multiprocessing, multitasking, multithreading, real-time and the like. The operating system performs basic tasks, including but not limited to: keeping track of files and directories on storage devices(s) 804; controlling peripheral devices, which may be controlled directly or through an I/O controller; and managing traffic on communication channels 812. Network communications instructions 816 may establish and maintain network connections with client devices (e.g., software for implementing transport protocols, such as TCP/IP, RTSP, MMS, ADTS, HTTP Live Streaming).

Computer-readable medium 810 may store speech processing instructions 820. Speech processing instructions 820, when executed by processor 802, can cause processor 802 to perform operations of parsing speech input to recognize keywords from the speech input, and of generating speech output. Computer-readable medium 810 may store significant location instructions 830. Significant location instructions 830, when executed by processor 802, can cause processor 802 to perform operations of determining, storing, and updating significant locations of a mobile device. Computer-readable medium 810 may store task instructions 840. Task instructions 840, when executed by processor 802, can cause processor 802 to perform operations of determining a personal geofence, determining whether a mobile device has entered or exited a personal geofence, and perform a task in response.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). For example, the data access daemon may be accessed by another application (e.g., a notes application) using an API. An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
determining, by one or more processors, that a venue previously visited by a mobile device is a significant location for a user of the mobile device;
receiving, by the one or more processors, a request for performing a task, the request including a query term that specifies a parameter of the task;
determining, based on a match between the query term and a pre-determined attribute of the venue, that the task is related to the venue;
predicting, by the one or more processors and based on a past usage pattern of the mobile device, that the mobile device will be located proximate to the venue; and
before the mobile device reaches a decision location, performing the task by the one or more processors, wherein the decision location is a location for the user to make a choice between continuing on a current travel path or making a detour for visiting the venue.

2. The method of claim 1, wherein determining that the venue is a significant location comprises at least one of:
determining that the user previously visited the venue at a frequency that is higher than a threshold frequency;
determining that the user previously stayed at the venue for more than a threshold amount of time; or
determining that the user previously purchased an item or a service at the venue.

3. The method of claim 1, wherein:
the request is a natural language speech input, and
the task includes providing a reminder for performing an activity related to the query term.

4. The method of claim 1, wherein predicting that the mobile device will be located proximate to the venue comprises:
monitoring a geographic or temporal distance between the mobile device and the venue according to a location sampling plan, the location sampling plan being determined based on a current location of the mobile device, a current motion reading of the mobile device, and the past usage pattern; and
determining that the mobile device will be located at the venue after a pre-specified lead time.

5. The method of claim 4, comprising determining the location sampling plan, wherein determining the location sample plan comprises:
determining, based on a travel velocity of the mobile device and the geographic distance between the mobile device and the venue, that a first location determination mechanism of the mobile device may have insufficient time to trigger performance of the task; and
in response, monitoring the geographic distance or temporal distance using a second location determination mechanism.

6. The method of claim 5, wherein the first location determination mechanism determines the current location of the mobile device using signals from one or more wireless local area network (WLAN), and the second location determination mechanism determines the current location of the mobile device using signals from a satellite positioning system.

7. The method of claim 1, wherein the past usage pattern comprises location information and transit information, the location information including a geographic location and a probability that the mobile device is located at the geographic location at a given time, the transit information including a probability that the mobile device transits from a first geographic location to a second geographic location at given time.

8. The method of claim 7, wherein predicting that the mobile device will be located proximate to the venue comprises:
determining, based on the transit information and a current location of the mobile device, that a probability that the mobile device is transiting from the first geographic location to the second geographic location exceeds a threshold value;
determining that, in the past, the mobile device visited the venue during a transit from the first geographic location to the second geographic location; and
predicting that the mobile device will be located proximate to the venue based on the current location and a heading of the mobile device.

9. The method of claim 7, wherein predicting that the mobile device will be located proximate to the venue occurs before the mobile device enters a stationary geofence of the venue.

10. A non-transitory computer-readable medium storing instructions operable to cause one or more processors to perform operations comprising:
determining, by one or more processors, that a venue previously visited by a mobile device is a significant location for a user of the mobile device;
receiving, by the one or more processors, a request for performing a task, the request including a query term that specifies a parameter of the task;
determining, based on a match between the query term and a pre-determined attribute of the venue, that the task is related to the venue;
predicting, by the one or more processors and based on a past usage pattern of the mobile device, that the mobile device will be located proximate to the venue; and
before the mobile device reaches a decision location, performing the task by the one or more processors, wherein the decision location is a location for the user to make a choice between continuing on a current travel path or making a detour for visiting the venue.

11. The non-transitory computer-readable medium of claim 10, wherein determining that the venue is a significant location comprises at least one of:
determining that the user previously visited the venue at a frequency that is higher than a threshold frequency;
determining that the user previously stayed at the venue for more than a threshold amount of time; or
determining that the user previously purchased an item or a service at the venue.

12. The non-transitory computer-readable medium of claim 10, wherein:
the request is a natural language speech input, and
the task includes providing a reminder for performing an activity related to the query term.

13. The non-transitory computer-readable medium of claim 10, wherein predicting that the mobile device will be located proximate to the venue comprises:
monitoring a geographic or temporal distance between the mobile device and the venue according to a location sampling plan, the location sampling plan being determined based on a current location of the mobile device, a current motion reading of the mobile device, and the past usage pattern; and
determining that the mobile device will be located at the venue after a pre-specified lead time.

14. The non-transitory computer-readable medium of claim 13, the operations comprising determining the location sampling plan, wherein determining the location sample plan comprises:
determining, based on a travel velocity of the mobile device and the geographic distance between the mobile device and the venue, that a first location determination mechanism of the mobile device may have insufficient time to trigger performance of the task; and
in response, monitoring the geographic distance or temporal distance using a second location determination mechanism.

15. The non-transitory computer-readable medium of claim 14, wherein the first location determination mechanism determines the current location of the mobile device using signals from one or more wireless local area network (WLAN), and the second location determination mechanism determines the current location of the mobile device using signals from a satellite positioning system.

16. The non-transitory computer-readable medium of claim 10, wherein the past usage pattern comprises location information and transit information, the location information including a geographic location and a probability that the mobile device is located at the geographic location at a given time, the transit information including a probability that the mobile device transits from a first geographic location to a second geographic location at given time.

17. The non-transitory computer-readable medium of claim 16, wherein predicting that the mobile device will be located proximate to the venue comprises:
determining, based on the transit information and a current location of the mobile device, that a probability that the mobile device is transiting from the first geographic location to the second geographic location exceeds a threshold value;
determining that, in the past, the mobile device visited the venue during a transit from the first geographic location to the second geographic location; and
predicting that the mobile device will be located proximate to the venue based on the current location and a heading of the mobile device.

18. The non-transitory computer-readable medium of claim 16, wherein predicting that the mobile device will be located proximate to the venue occurs before the mobile device enters a stationary geofence of the venue.

19. A system comprising:
one or more processors; and
non-transitory computer-readable medium storing instructions operable to cause one or more processors to perform operations comprising:
determining, by one or more processors, that a venue previously visited by a mobile device is a significant location for a user of the mobile device;
receiving, by the one or more processors, a request for performing a task, the request including a query term that specifies a parameter of the task;
determining, based on a match between the query term and a pre-determined attribute of the venue, that the task is related to the venue;
predicting, by the one or more processors and based on a past usage pattern of the mobile device, that the mobile device will be located proximate to the venue; and
before the mobile device reaches a decision location, performing the task by the one or more processors, wherein the decision location is a location for the user to make a choice between continuing on a current travel path or making a detour for visiting the venue.

20. The system of claim 19, wherein determining that the venue is a significant location comprises at least one of:
determining that the user previously visited the venue at a frequency that is higher than a threshold frequency;
determining that the user previously stayed at the venue for more than a threshold amount of time; or
determining that the user previously purchased an item or a service at the venue.

21. The system of claim 19, wherein:
the request is a natural language speech input, and
the task includes providing a reminder for performing an activity related to the query term.

22. The system of claim 19, wherein predicting that the mobile device will be located proximate to the venue comprises:
monitoring a geographic or temporal distance between the mobile device and the venue according to a location sampling plan, the location sampling plan being determined based on a current location of the mobile device, a current motion reading of the mobile device, and the past usage pattern; and
determining that the mobile device will be located at the venue after a pre-specified lead time.

23. The system of claim 22, the operations comprising determining the location sampling plan, wherein determining the location sample plan comprises:
determining, based on a travel velocity of the mobile device and the geographic distance between the mobile device and the venue, that a first location determination mechanism of the mobile device may have insufficient time to trigger performance of the task; and
in response, monitoring the geographic distance or temporal distance using a second location determination mechanism.

24. The system of claim 23, wherein the first location determination mechanism determines the current location of the mobile device using signals from one or more wireless local area network (WLAN), and the second location determination mechanism determines the current location of the mobile device using signals from a satellite positioning system.

25. The system of claim 19, wherein the past usage pattern comprises location information and transit information, the location information including a geographic location and a probability that the mobile device is located at the geographic location at a given time, the transit information including a probability that the mobile device transits from a first geographic location to a second geographic location at given time.

26. The system of claim 25, wherein predicting that the mobile device will be located proximate to the venue comprises:
determining, based on the transit information and a current location of the mobile device, that a probability that the mobile device is transiting from the first geographic location to the second geographic location exceeds a threshold value;
determining that, in the past, the mobile device visited the venue during a transit from the first geographic location to the second geographic location; and
predicting that the mobile device will be located proximate to the venue based on the current location and a heading of the mobile device.

27. The system of claim 25, wherein predicting that the mobile device will be located proximate to the venue occurs before the mobile device enters a stationary geofence of the venue.
